(19) United States
(12) Patent Application Publication
(10) Pub. No.: US 2019/0090057 A1
(43) Pub. Date: Mar. 21, 2019

(54) AUDIO PROCESSING DEVICE

(71) Applicant: Thomson Licensing, Issey-les-Moulineaux (FR)

(72) Inventors: Michael Drexler, Gehrden (DE); Michael Arnold, Isernhagen (DE); Peter Georg Baum, Hannover (DE); Stefan Kubsch, Hohnhorst (DE); Uwe Riemann, Braunschweig (DE); Jens Spille, Hemmingen (DE)

(21) Appl. No.: 16/085,019

(22) PCT Filed: Mar. 15, 2017
(86) PCT No.: PCT/EP2017/056069

§ 371 Date: Sep. 14, 2018

(30) Foreign Application Priority Data
Mar. 15, 2016 (EP) 16305274.9

(51) Int. Cl. H04R 3/04

(52) U.S. Cl. CPC H04R 3/04; H04R 2430/01

(57) ABSTRACT

The disclosure relates to an audio processing device. This device comprises an audio processing component, e.g. DSP, a microprocessor, memory and a communication interface. Said microprocessor receives via said communication interface two or more listening profiles from personal devices of two or more persons. Said microprocessor comprises means for calculating a combined listening profile out of the two or more received listening profiles and means for calculating a compensation gain profile out of the combined listening profile. Said audio processing component makes use of the compensation gain profile to adapt the audio processing to the listening deficits of the two or more persons who are jointly consuming the audio presentation from the audio processing device.

The disclosure relates to an audio processing device such as a TV set, set top box, AV receiver, radio or any other HiFi or stereo component and to a method of processing audio content.

### BACKGROUND

Today, the population is becoming older and older, the number of people with listening deficits is growing. Additionally, a lot of younger people have such deficits. Special frequency adaptation (equalization) of playback devices compensates for that if no personal in-ear devices are used.

A personal listening profile may define the amount of frequency adaptation. This enables automatization of the adaptation. If such a profile is stored on a personal device, like a smartphone, or in a cloud, then automated frequency adaptation of playback devices surrounding the listener without interaction is an easy task.

From U.S. Pat. No. 7,680,465 a method and an apparatus for sound enhancement based on user-specific audio processing parameters is known. The user-specific audio processing parameters may be based on a user auditory profile.

From U.S. Pat. No. 8,761,421 a hearing aid device is known which has the capability to receive one of a plurality of hearing aid profiles over a communication channel and to use it for sound adaptation.

From US 2008/0040116 a TV hearing system is known that utilizes a pre-established personal hearing profile of a hearing-impaired user to selectively enhance the audio output of a standard television set, thereby providing better intelligibility of the audio as heard by the hearing-impaired user.

From U.S. Pat. No. 8,989,406 it is known a user profile based audio adjustment technique. A user profile is set-up in one electronic device. The recorded user audio profile will be exported to other compatible electronic devices.

### SUMMAR

The personal listening profile contains information about (frequency dependent) listening deficits of the owner. It may be created by a doctor or by a self-experiment using a smart phone or TV app or another computer application program. This listening profile can be used by any audio device to compensate for the deficits. This may be a TV-set, a radio or amplifier, an audio-guide in a museum, or a supermarket or cinema sound system.

Preferred is a storage of the profile connected to the listener (smartphone) and a wireless automated communication with the audio device when the listener is approaching or near the device.

Special notice has to be taken if more than one listener with a personal profile has to be adapted, or if listeners with and without a personal profile listen to one audio device jointly. In such a situation it is desirable to reach a compensation from which all people benefit without having a disadvantage for one or some of them.

These and other objects are solved with an audio processing device according to the independent claim 1.

According to the solution covered by the independent claim 1, the audio processing device comprises an audio processing component, a microprocessor, memory and a communication interface. Said microprocessor receives via said communication interface two or more listening profiles from personal devices of two or more persons who intend to jointly consume audio content presented by the audio processing device. Said microprocessor comprises means for calculating a combined listening profile out of the two or more received listening profiles and means for calculating a compensation gain profile out of the combined listening profile, wherein said audio processing component makes use of the compensation gain profile to adapt the frequency dependent audio processing to the listening deficits of the two or more persons.

The dependent claims contain advantageous developments and improvements to the audio processing device according to the disclosure.

For the calculation of the combined profile it is advantageous that said listening profiles are subdivided into subbands where a profile value is assigned to each subband and for calculating said combined listening profile the arithmetical or geographical mean values are calculated per subband.

For the compensation of the combined listening profile it is advantageous to calculate a compensation gain profile by mirroring the combined profile along the horizontal axis above the combined profile, which touches the combined profile at the maximum point in the combined profile.

The audio processing device may be integrated in one of a TV set, digital set top box, a personal computer, an AV receiver, or another stereo component. These are devices which likely are used for jointly consuming audio content.

### DRAWINGS

An exemplary embodiment of the present disclosure is shown in the drawing and is explained in greater detail in the following description.

In the drawings:

FIG. 1 shows a care system TV sound detector and a sound processing device according to the present principles;

FIG. 2 shows an example of two distinct hearing profiles and the generation of a combined profile out of them as well as the corresponding sound adaptation needed to compensate for the combined hearing profile;

FIG. 3 shows an example with three distinct hearing profiles and the generation of a combined profile out of them as well as the corresponding sound adaptation needed to compensate for the combined hearing profile; and

FIG. 4 shows an example of a method of processing an audio content that may be implemented in the sound processing device of FIG. 1.

### EXEMPLARY EMBODIMENTS

The present description illustrates the principles of the present disclosure. It will thus be appreciated that those skilled in the art will be able to devise various arrangements that, although not explicitly described or shown herein, embody the principles of the disclosure and are included within its scope.

All examples and conditional language recited herein are intended for educational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the diagrams presented herein represent conceptual views of illustrative circuitry embodying the principles of the disclosure.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read only memory (ROM) for storing software, random access memory (RAM), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

People with listening deficits prefer a sound compensation on playback devices adapted to their personal deficits. This may be an increase of higher frequencies or frequency bands, or a general increase of loudness. Sometimes, this is done manually every time the listener uses the device by manually adjusting the equalizer. Significant more comfort enables the usage of a personal listening profile stored on a personal device, e.g. a smartphone, smartwatch or in a cloud connected to such a device. In case of the listener approaches a playback device, his smartphone connects automatically to this device by means of wireless communication such as WLAN, Bluetooth or other near field communication protocols. The smartphone sends the stored listening profile to the playback device, which then is able to compensate for the listening deficits by adjusting the equalizer correspondingly.

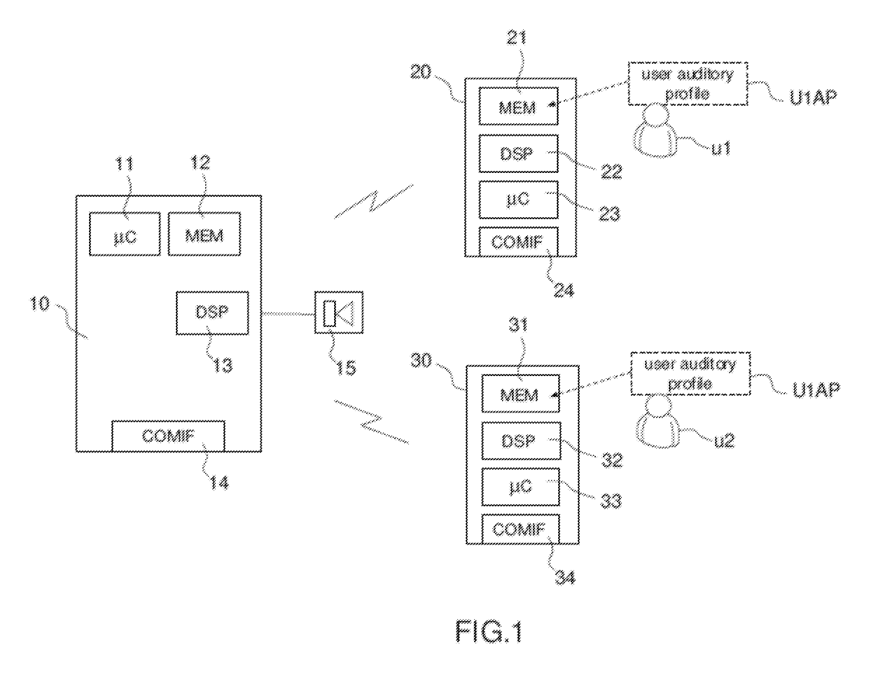

FIG. 1 illustrates a situation where two persons are enjoying watching TV. The two persons U1 and U2 each have their own auditory profile U1AP resp. U2AP stored in their personal smart phones 20, 30. Typically the personal listening profile will be recorded during a visit of the doctor, an acoustic specialist or at the pharmacy. Starting nowadays and more in future such service will be offered by mass products, too such as smart phones, tablet and computers by means of a specialized app. The recorded listening profile U1AP will be stored in memory 21 of smart phone 20 and the recorded listening profile U2AP will be stored in memory 31 of smart phone 30. Typically the memory 21 will be provided in the form of an SD card or micro SD card memory which are based on FEPROM technique. Both smart phones 20, 30 further comprise a digital signal processor DSP 22, 32, a microcontroller 23, 33 and a communication interface 24, 34. DSP 22, 32 is an audio DSP, i.e. the audio processing will be performed in this block. This DSP has equalizing capability and adapts the sound to the listening profile recorded in the memory block 21, 31. This way, the sound generated by smart phone 20, 30 and output via earphones, headphones or loudspeakers is adapted to the personal listening profile of the user of the smart phone.

FIG. 1 also shows TV set 10. Also this TV set among further components is equipped with micro controller 11, memory block 12, DSP 13 and communication interface 14. The other components, such as display, tuner power supply, etc. are not shown. What is shown is an external loudspeaker 15 connected to the TV set 10 which can be exemplified in the form of a sound bar. Of course the sound generated in DSP 13 is output via the loudspeaker 15. Now, if both persons U1 and U2 are jointly watching TV, each person will transfer his listening profile U1AP and U2AP to the TV set 10. Preferably, the listening profiles are wirelessly transferred to the TV set. This may be done by means of the Bluetooth communication protocol, by means of WLAN protocol or any other nearfield communication protocol. Alternatively, since a lot of TV sets are equipped with SD card slot, the SD card of the phone may be inserted into the TV set and the profile will be copied to the TV set. It may also be done by connecting the phone to the TV set via USB cable since modern TV sets typically are also equipped with USB port.

Next, after both users U1 and U2 have transferred their listening profiles, the TV set after receiving a corresponding command from user menu, will calculate a combined listening profile out of the two received listening profiles.

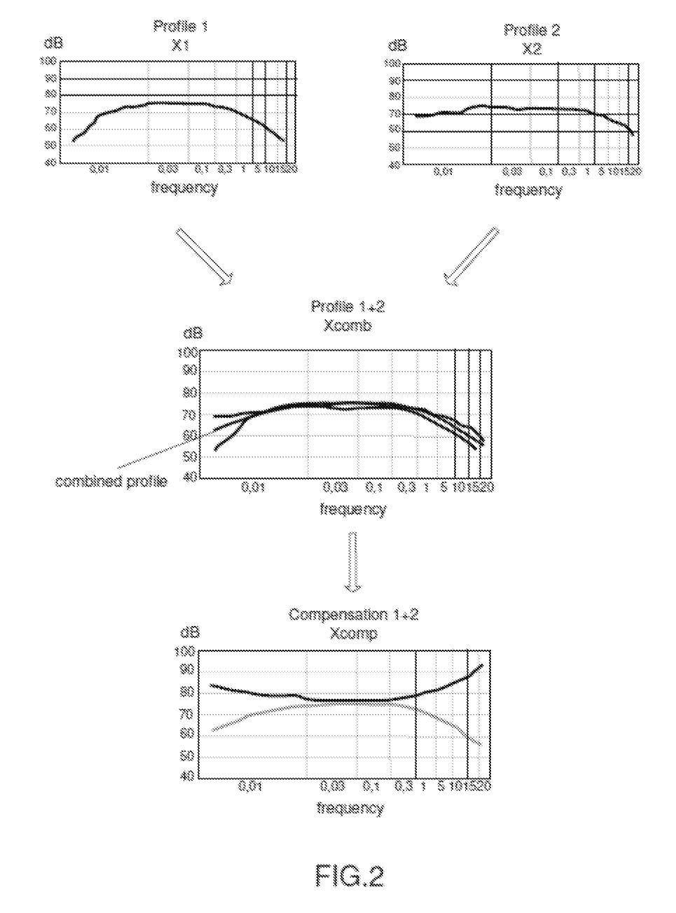

FIG. 2 shows two listening profiles as examples. The listening profile U1AP of user U1 shows attenuations for low and high frequencies. The listening profile of user U2 shows attenuations mainly in the high frequency range. To compensate the listening profile of user U1 amplifying the low and high frequencies by the DSP 13 will give the listener back a linear listening feeling. For user U2 amplification mainly in the high frequency range is good for compensating his listening profile.

The calculation of the combined listening profile is illustrated in the mid diagram of FIG. 2. Both listening profiles U1AP and U2AP are depicted in black. The combined listening profile is shown in dark grey color. As seen in the drawing, the combined listening profile shows more attenuation in the low frequency range than in the profile U2AP but less attenuation in the low frequency range than profile U1AP, so it is a compromise for both users U1 and U2. Likewise, in the high frequency range the combined profile shows more attenuation than in the profile U2AP but less attenuation than in the profile U1AP.

For calculating the combined profile, the arithmetical mean value is calculated according to the formula

$${X}_{comb} ( f ) = \frac{1}{n} * {\sum }_{i = 1}^{n} {X}_{i} ( f )$$

where n is equal to the number of profiles to be combined.

Alternatively, the geometrical mean value may be calculated according to the formula

$${X}_{comb} ( f ) = \sqrt{{\prod }_{i = 1}^{n} {X}_{i} ( f )}$$

where n is equal to the number of profiles to be combined. Typically, both calculation methods can be refined by subdividing the frequency range into a plurality of subbands what is often been done in audio coding technologies before applying above formulas.

The lower part in FIG. 2 depicts the combined listening profile in lighter grey and the compensation gain profile resulting from that for compensating for the listening deficits according to the combined listening profile.

The calculation of the gain curve is done by mirroring the combined profile along the horizontal axis above the combined profile, which touches the combined profile at the maximum point in the combined profile.

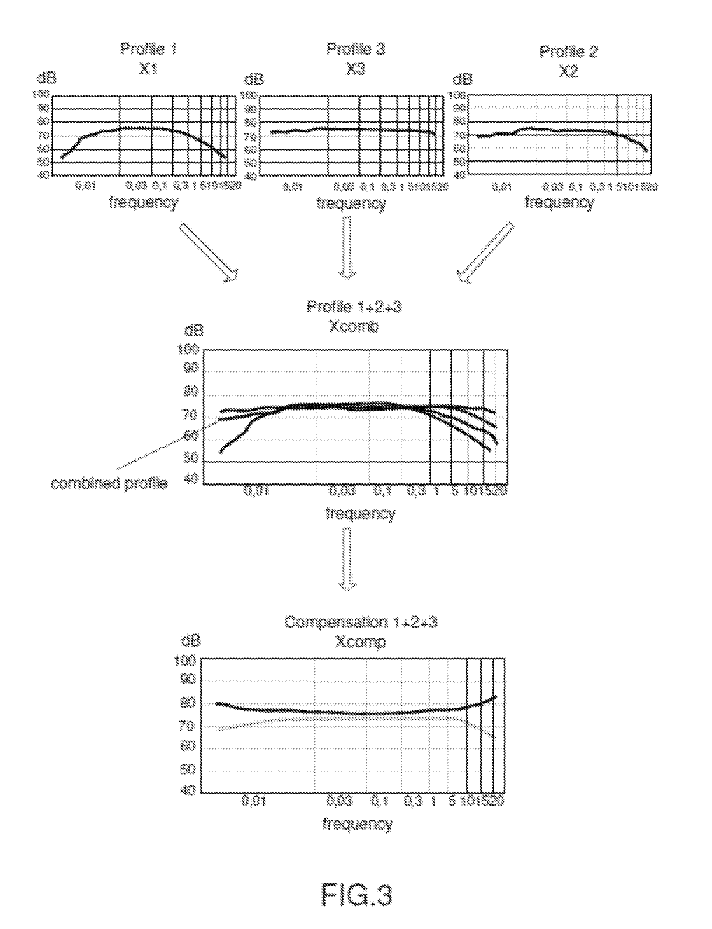

FIG. 3 shows an example with three different listening profiles. In the top row the three listening profiles are depicted, separately. In the middle row the combined profile is shown together with the three listening profiles in overlaid form. The last row again shows the combined profile and its corresponding compensation gain profile.

The whole process of collecting listening profiles and calculating a combined profile and compensation gain profile can be automated. If people are entering a WLAN network, the audio profile may be uploaded to the audio device in the room if it is for making presentations to the public. People without a profile can be detected for instance from a connected smartphone which does not provide stored profile, or by a camera or other sensors. People without a profile are regarded as people with a linear listening profile. All these profiles are combined as explained before. Attenuation in common frequency bands is fully amplified, attenuation in only some profiles is only partly amplified. This will result in an optimal compromise for all the listeners.

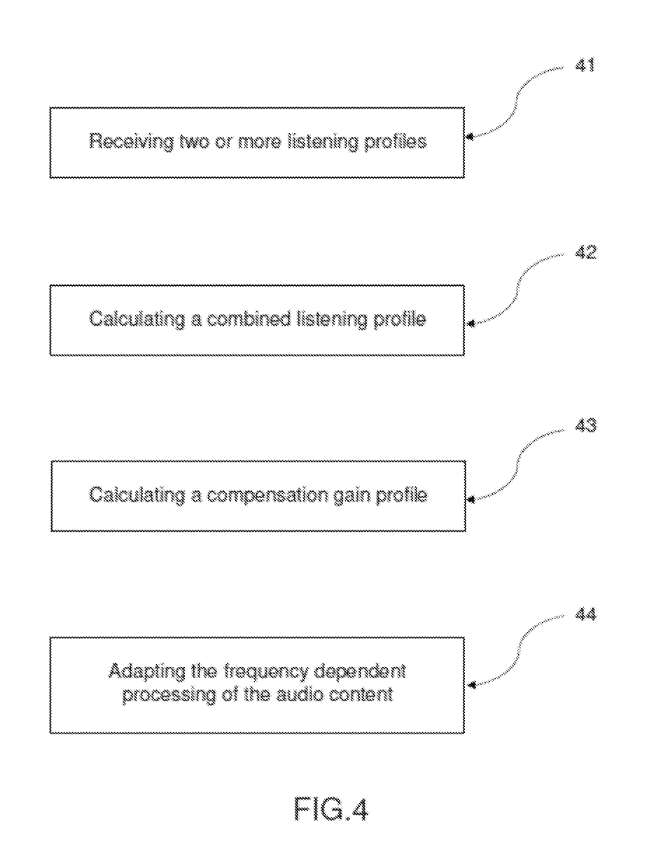

FIG. 4 illustrates a method of processing an audio content. In a first operation 41, two or more listening profiles (U1AP, U2AP) are received from personal devices (20, 30) of two or more persons (U1, U2). In a second operation 42, a combined listening profile is calculated out of the two or more received listening profiles (U1AP, U2AP). In a third operation 43, a compensation gain profile is calculated out of the combined listening profile. In a fourth operation 44, the frequency dependent processing of the audio content is adapted to the listening deficits of the two or more persons by using the compensation gain profile.

The disclosure is not restricted to the exemplary embodiments described here. There is scope for many different adaptations and developments which are also considered to belong to the disclosure.

Given the teachings herein, one of ordinary skill in the related art will be able to contemplate similar implementations or configurations of the proposed care system TV sound detector.

1. Audio processing device comprising:
an audio processing component;
a microprocessor;
memory;
a communication interface,
wherein said microprocessor receives via said communication interface two or more listening profiles from personal devices of two or more persons, and wherein said microprocessor comprises means for calculating a combined listening profile out of the two or more received listening profiles and means for calculating a compensation gain profile out of the combined listening profile, wherein said audio processing component makes use of the compensation gain profile to adapt the frequency dependent audio processing to the listening deficits of the two or more persons.

2. The audio processing device according to claim 1, wherein said listening profiles (U1AP, U2AP) are subdivided into subbands where a profile value is assigned to each subband and for calculating said combined listening profile the arithmetical or geographical mean values are calculated per subband.

3. The audio processing device according to claim 1, wherein for said combined listening profile a compensation gain profile is calculated by mirroring the combined profile along the horizontal axis above the combined profile, which touches the combined profile at the maximum point in the combined profile.

4. The audio processing device according to claim 1, being integrated in one of a TV set, digital set top box, a personal computer, an AV receiver, or another stereo component.

5. A method of processing an audio content, the method comprising:
receiving two or more listening profiles from personal devices of two or more persons;
calculating a combined listening profile out of the two or more received listening profiles;
calculating a compensation gain profile out of the combined listening profile;
adapting the frequency dependent processing of the audio content to the listening deficits of the two or more persons by using the compensation gain profile.

6. The method according to claim 5, wherein said listening profiles are subdivided into subbands where a profile value is assigned to each subband and for calculating said combined listening profile the arithmetical or geographical mean values are calculated per subband.

7. The method according to claim 5, wherein for said combined listening profile a compensation gain profile is calculated by mirroring the combined profile along the horizontal axis above the combined profile, which touches the combined profile at the maximum point in the combined profile.
